(19) United States
(12) Patent Application Publication
(10) Pub. No.: US 2013/0275092 A1
(43) Pub. Date: Oct. 17, 2013

(54) Modeling Concrete Structures

(71) Applicant: FLUOR TECHNOLOGIES CORPORATION, Aliso Viejo, CA (US)

(72) Inventor: Damodhar Murali, Gurgaon (IN)

(73) Assignee: Fluor Technologies Corporation, Aliso Viejo, CA (US)

(21) Appl. No.: 13/864,940

(22) Filed: Apr. 17, 2013

(30) Foreign Application Priority Data
Apr. 17, 2012 (IN) 1185/DEL/2012

(51) Int. Cl. G06F 17/50

(52) U.S. Cl. CPC G06F 17/5004
USPC 703/1

(57) ABSTRACT

A method of modeling concrete construction structures is presented. During a design or engineering phase of a construction product, engineers typically use multiple modeling tools when creating designs. Often the tools use incompatible data formats when exporting or importing concrete structures. Contemplated methods include exporting concrete construction objects as non-concrete objects comprising other materials (e.g., steel) that are compatible with the data formats. The temporary non-concrete objects can be converted via a conversion engine to a desirable format, possibly taking into account coordinate transformations. The non-concrete objects can then be imported into another tool and then changed back to a concrete material.

This application claims the benefit of priority to Indian patent application serial number 1185/DEL/2012 filed on Apr. 17, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is concrete construction modeling technologies.

### BACKGROUND

When design engineers work on designing capital construction projects (e.g., processing plants, power plants, etc.), the engineers often have to migrate their plant designs, or components of their plant designs, from one modeling tool to another. Unfortunately, not all modeling tools are equal or have equivalent modeling capabilities. One example where such issues arise includes modeling concrete construction objects. For example, incompatibilities arise between RISATechnologies™ structural analysis modeling tools (e.g., RISA-3D), which lacks support for exporting concrete structures, and Intergraph® PDS® computer aided design engine. Engineers require support of exporting concrete structures from one modeling engine that lacks support for exporting concrete structures and importing the concrete members into another modeling engine.

Others have put forth effort toward transforming data across formats. For example, U.S. Pat. No. 7,260,777 to Fitzsimons et al. titled “Apparatus, Method, and System for Transforming Data”, filed Aug. 17, 2001, describes automatically making associations web page elements and converting between disparate data and device format types. Although useful with respect to converting data formats for content, Fitzsimons fails to provide insight into managing concrete structures across design tools, especially when the design tools lack support for exporting concrete data.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for method of modeling concrete structures.

### SUMMARY OF THE INVENTION

The inventive subject matter provides apparatus, systems and methods in which one can migrate construction objects from one modeling engine to another when the modeling engines have incompatible data models. One aspect of the inventive subject matter includes a method of modeling concrete structures. The method can include providing access to a source construction modeling engine, which lacks support for exporting concrete members in a desirable file format. For example, some modeling engines (e.g., RISATechnologies® structure analysis engines) lack the ability to export concrete structures in a format useful for another, different modeling tool. For example, some standard file formats lack support for concrete-based structures (e.g., Steel Detailing Neutral Format (SDNF)). The source modeling construction engine can model a desirable concrete construction structure (e.g., beam, tube, column, brace, etc.). The method can further include exporting the construction structure as a non-concrete construction object as a standardized file format that lacks support for concrete; a concrete beam can be exported as a steel beam in SDNF for example. Another step of the method includes using a conversion engine to identify the non-concrete construction object as a representation of the desirable structure. In some embodiments, the non-concrete construction objects can be identify based on user assigned tags, automatically assigned tags, object attributes (e.g., type of material, type of structure, etc.) or other information that can conform to the first format. The conversion engine can also converts the non-concrete construction object from the first format to a second, different format that more closely aligns with other destination design tools capable of supporting concrete members. The method further includes importing the converted construction object into a destination modeling engine that can render the concrete member. The destination modeling engine can then be configured to present the object as a concrete structure.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of construction modeling ecosystem.

FIG. 2 illustrates possible issues when migrating construction structures from one modeling engine to another.

FIG. 3 illustrates conversion of a non-concrete construction object to a concrete construction object.

FIG. 4 is a schematic of a method of modeling concrete structures.

### DETAILED DESCRIPTION

It should be noted that while the following description is drawn to a computer/server construction modeling or conversion engines, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including receiving signals that instruct conversion engines to convert non-concrete modeled objects from one format to another and to instantiate concrete structures in a modeling engine from the non-concrete object.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within this document, the terms “coupled to” and “coupled with” are also construed to me “communicatively coupled with” when applied to a networking context.

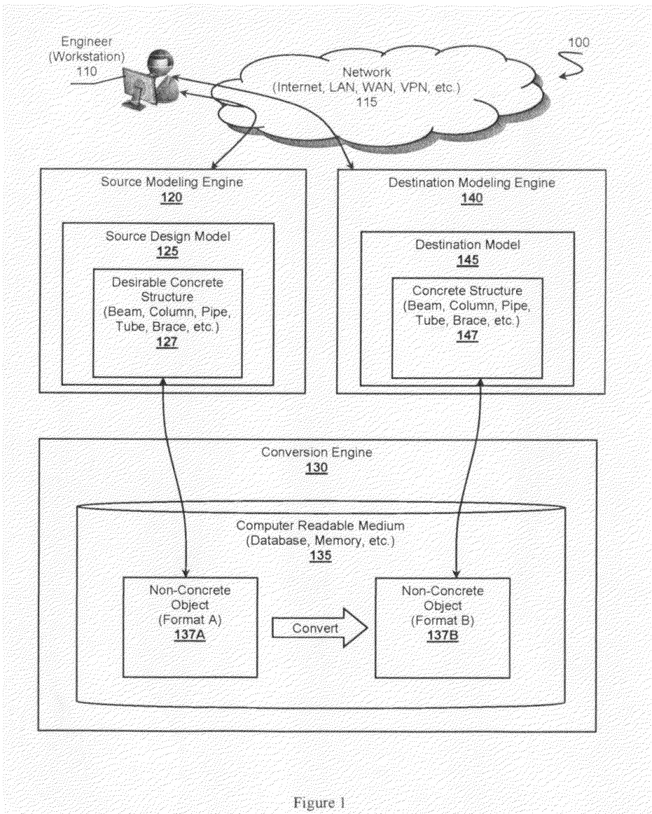

In FIG. 1 modeling ecosystem 100 represents a common scenario where engineer 110 uses source modeling engine 120 to create source design model 125. For example, source modeling engine 120 could include RISATechnologies structure analytics engine (e.g., RISA-3D, etc.). Engineer 110 models one or more desirable concrete structures 127 (e.g., beams, columns, pipes, tubes, braces, foundations, etc.) in construction source design model 125. Conversion engine 130 converts a non-concrete representation of desirable concrete structure 127 into a format and configuration acceptable to source modeling engine 140.

Conversion engine 130 is illustrated as a distinct computing system separate from source modeling engine 120 or destination modeling engine 140. It is also contemplated that some or all of the roles or functionality of conversion engine 130 can be integrated into source modeling engine 120 or destination modeling engine 140. Further, engineer 110 is illustrated as accessing the various components of ecosystem 100 over network 115. One should also appreciate that the roles, functionality, or responsibilities of source modeling engine 120, conversion engine 130, or destination modeling engine 140 can be incorporated into one or more workstations local to engineer 110.

During the design or engineering process, engineer 110 often must transport desirable concrete structure 127 to one or more other tools represented by destination modeling engine 140. For example, source design model 125 or it components including desirable concrete structure 127 might shift from RISATechnologies RISA-3D to Intergraph PDS® computer aided design engine in Intergraph's SmartPlant® suite of software. Unfortunately, incompatibilities can be present between source modeling engine 120 and destination modeling engine 140. More specifically, RISATechnologies tools lack the ability to export desirable concrete structure 127 as a concrete structure in a manner that Intergraph PDS can readily understand. Intergraph PDS is not able to a priori automatically convert desirable concrete structure 127 modeled concrete structure 147 in destination construction model 145.

In a preferred embodiment, source modeling engine 120 lacks support for exporting desirable concrete structure 127 as a concrete member in a useful format that can be imported into destination modeling engine 140. However, modeling engine 120 comprises modules allowing export of modeled structures in some fashion. For example, modeling engine 120 could support exporting design elements based on materials other than concrete according to one or more standardized data formats. Although source modeling engine 120 lacks support for exporting concrete structures in a suitable format, source modeling engine 120 could support exporting structures as steel structures according to Steel Detailing Neutral Format (SDNF) or CIMSteel integration standard format.

In such embodiments where desirable concrete structure 127 can not be exported as a concrete structure, engineer 110 can export desirable concrete structure 127 as non-concrete object 137A in a first format (e.g., SDNF, CIMSteel, etc.) where the corresponding exported object is labeled as comprising an alternative material, possibly steel. Conversion engine 130 applies one or more rules to convert non-concrete object 137A into an acceptable format for importation into destination modeling engine 140. Although the example illustrates converting non-concrete object 137A into another non-concrete object 137B, one should appreciate that the conversion could result in an object that comprises concrete. Further, one should appreciate that the conversion is not necessarily a file format conversion. In more preferred embodiments non-concrete object 137B is stored on computer readable medium 135 in a modified version of the format used to store non-concrete object 137A; a modified SDNF format for example. Rather, the data structure of non-concrete object 137B has been modified to align with the capabilities of destination molding engine 140.

Consider a scenario where engineer 110 has one or more of desirable concrete structure 127 that must be imported into destination model 145 as a next phase of design or engineering. Engineer 110 creates desirable concrete structure 127 in source modeling tool 120 and assigns desirable concrete structure 127 appropriate attributes (e.g., material, shape, size, dimensions, origin, structure name, structure identifier, catalog number, etc.). Especially preferred attributes include structure type attributes (e.g., a member type, a shape name, an angle identifier, etc.). Thus, all desirable concrete structures 127 have attributes and attribute values describing the nature of the objects. In some embodiments, source modeling engine 120 can be configured to automatically tag objects with metadata. For example, the tags can include user or machine assigned metadata bound to the object where the metadata does not affect the modeled form of the object. When desirable concrete structure 127 is exported to a first file format (e.g., SDNF), the tags, labels, attributes, or metadata (collectively referenced as “tags”) is also exported.

Conversion engine 130 searches the exported file for objects having specific tags where the tags identify which objects are non-concrete objects 137A and are targets for conversion. Once the conversion engine 130 finds relevant objects, it can convert the objects (or file) from the first file format to a second file format. In more preferred embodiments, the second file format comprises a modified form of the first format. For example, an SDNF file can be converted to another SDNF file where only attributes or attribute values of objects have changed.

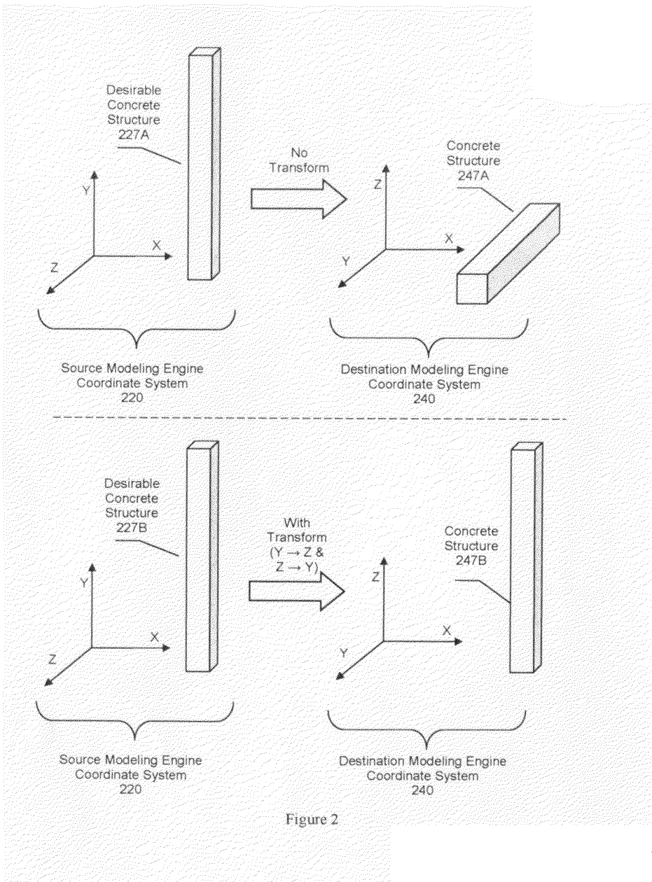

FIG. 2 illustrates some of the considerations that must be taken into account when the conversion engine converts structures from one format to another. For the example shown, there exists an incompatibility between coordinate systems of the modeling engines. More specifically, source modeling engine coordinate system 220 assumes a Y coordinate corresponds to a vertical measure while a Z coordinate corresponds to a depth measure. However, destination modeling engine coordinate system 240 assumes an opposite orientation between Z and Y. Referring to the top portion of FIG. 2, if desirable concrete structure 227A imported as concrete structure 247A without conversion, then concrete structure 247A would have the wrong dimensions and would be incompatible with the target construction model in the destination modeling engine. However, referring to the bottom portion of FIG. 2, after applying conversion rules, desirable concrete structure 227B is properly converted for use as concrete structure 247B.

In more preferred embodiments, the conversion engine converts from a first coordinate system associated with the source modeling engine to a second different coordinate system associated with the destination modeling engine. In a scenario where objects are exported from RISATechnologies analytics engines to Intergraph PDS engines, the first format can be SDNF format and the second format can be a modified version of the SDNF format with a convert coordinate system.

The conversion engine can employ rules beyond coordinate conversion. In some embodiments, the conversion engine can use one or more rules sets governing conversion of non-concrete construction objects from the first format to a second format as a function of the properties of the modeling engines. Example properties of the modeling engines can include vendor, version number, license information, current jurisdiction where the tool is in use, target jurisdiction where the project will be built, or other information. These properties can then be used to select one or more fabrication rules, design guidelines, conventions, or other guidelines that affect the conversion process. Thus, the conversion engine can automatically determine which rules sets should be used when converting non-concrete objects to concrete objects.

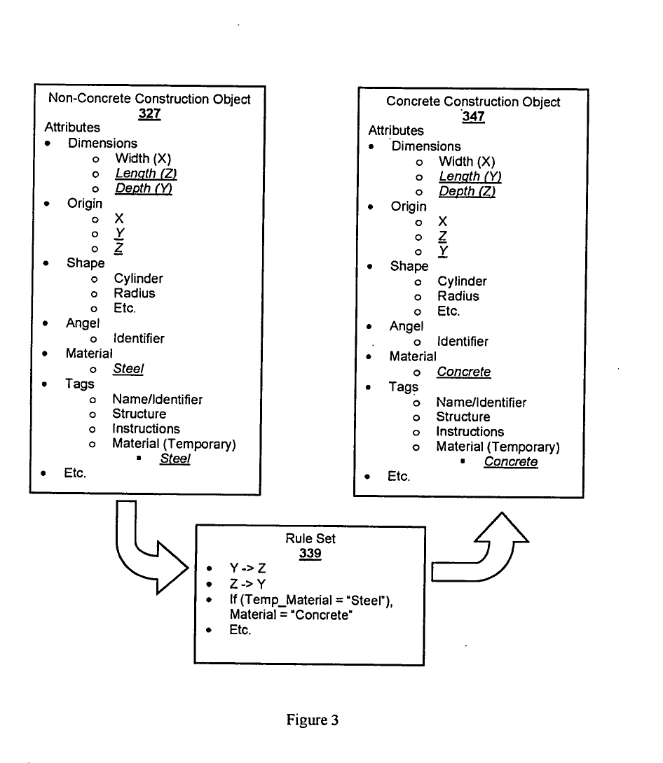

In FIG. 3, non-concrete construction object 327 is converted to concrete construction object 347 as an example. Non-concrete object 327 comprises a plurality of attributes that can be assigned automatically by the source modeling engine. Of particular note, non-concrete object 327 has a set of dimensions and an origin defined according to a coordinate system of the source modeling engine: a right-handed coordinate system where Z represents length and Y represents depth. A conversion engine applies rules set 339 to non-construction object 327 to generate concrete construction object 347 for importation into a destination modeling engine. Rules set 339 includes one or more rules that govern how the coordinate systems should be treated. In this example, the attributes that depend on a Y coordinate are transformed to depend on a Z coordinate and similarly attributes that depend on a Z coordinate are transformed to depend on a Y coordinate. As discussed previously, the format used to present the objects does not necessarily have to change. Although the attributes have been modified, the format of the data can remain the same or can be slightly modified within the scope acceptable to the destination modeling engine.

In some embodiments, non-construction objects 327 can include various attributes including shapes, angles, materials, tags, or other information. Any combination of these attributes can be used to identify non-concrete construction object 327 as a target for conversion. For example, rule set 339 can be configured to search for all objects with a “Material (Temporary)” tag set to “Steel” and convert such objects to a desirable format.

Rule set 339 can be distributed across one or more components of the ecosystem. For example, a first portion of rule set 339 can be used by a standalone conversion engine to transform coordinate systems of the objects. A second portion of rule set 339 can be integrated into a macro of the target modeling engine (e.g., Intergraph PDS) where the macro converts material types from “steel” to “concrete” according to the rules.

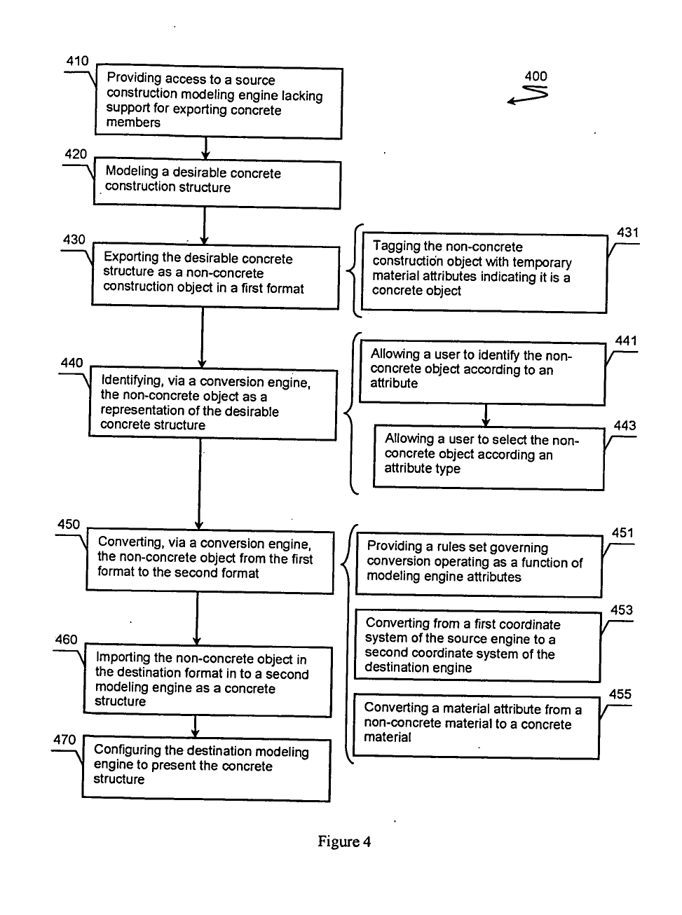

FIG. 4 illustrates a method of modeling concrete construction structures in an environment where concrete construction structures can not be easily exported from one modeling tool to another. Step 410 includes providing access to a source construction modeling engine that lacks support for exporting concrete members in a suitable format accessible to a destination modeling tool. Example construction modeling engines lacking such abilities include RISATechnologies's RISA-3D, which does not support exporting concrete members via SDNF formats.

Step 420 includes modeling a desirable concrete construction structure within the source construction modeling engine. For example, an engineer can access RISA-3D, after suitable authentication or authorization has been granted, to begin developing a structural analysis model and analyzing the materials within the model. One should note the source construction modeling engine can model concrete structures, but can not export such structures in a manner that a destination modeling engine (e.g., Intergraph PDS) can import.

Step 430 includes exporting the desirable concrete construction as a non-concrete construction object according to a first format. The desirable concrete construction structure can be exported as a steel member having specific attributes (e.g., dimensions, shape, origin, material type, etc.) preferably in an industry standard format (e.g., SDNF). Optionally step 431 can include tagging the non-concrete construction object with a temporary material attribute (other than concrete) where the tag can be used to aid in identifying the non-concrete object as a target concrete object requiring conversion. One should appreciate that using a temporary material attribute set to “steel” or other value allows the first modeling engine to export the non-concrete construction object properly in the standardized format (e.g., SDNF) while also allowing a conversion engine to identify the object for conversion.

Step 440 includes using a conversion engine other than the source modeling engine to identify the non-concrete construction object as a representation of the desirable concrete construction structure. The conversion engine can search for relevant non-concrete objects by comparing selection criteria to attributes of the objects. In some embodiments, method 400 can comprise step 441, which includes allowing a user to identify the non-concrete construction by attribute type (e.g., material type, shape name, angle identifier, etc.). Still further, step 443 can include allowing the engineer or other user to select the non-concrete construction object among multiple non-concrete construction objects by an attribute type. For example, an engineer or even the conversion engine can select all objects having attributes satisfying the criteria of being tagged as “beams” and comprising a temporary material attribute of “hot rolled steel”.

Step 450 includes converting the non-concrete construction object from the first format to a second different format. In more preferred embodiments, the non-concrete object is converted from SDNF format to a modified SDNF format that can be imported by the destination modeling engine where the structure of the data remain compliant with the SDNF format rules as understood by the destination modeling engine, and where attribute values change in preparation for importing. It is also contemplated that the conversion engine could convert the non-construction object to completely different standard; SDNF to CIMSteel or vice versus for example, depending one the capabilities of the destination tool.

Step 451 can include providing a rules set that governs conversion of the non-concrete construction from the first format to the second, different format as a function of properties or attributes of the source and destination modeling engines. In view that each modeling engine can serve a different purpose (e.g., structural analysis, 3D layout, process and control, piping runs, etc.), the disparity between modeling engines can be quite larger. The rules sets can be customized for mapping between the modeling engines or can be auto selected by the conversion engine when exporting and importing actions are taken. For example, the conversion engine can determine that version number and vendor for the source modeling tool and select an appropriate rules module comprising rules about the tool's coordinate system. When the conversion engine identifies the destination modeling tool, the conversion engine can instantiate a coordinate transformation rules set that instructs the conversion engine how to transform the coordinates of the source tool into coordinates usable by the destination tool as suggested by step 453. Step 453 includes converting from a first coordinate system associated with the source modeling engine to a second different coordinate system associated with the destination modeling engine. Still further, the rule sets can govern how material attributes are changed to target the destination tool as indicated by step 455, which includes converting a material attribute of the non-concrete construction object from a non-concrete material identifier (e.g., steel, wood, cold formed steel, hot rolled steel, aluminum, etc.) to a concrete material identifier, possibly as a function of one or more temporary material attributes.

One should appreciate that the inventive subject matter can also be considered converting a material attribute of a steel construction object from a steel material identifier (e.g., steel, cold formed steel, hot rolled steel, etc.) to a non-steel material identifier as a function of one or more temporary material attributes. Although method 400 is directed to converting to from non-concrete to concrete, contemplated methods could equally include converting from steel to non-steel (e.g., wood, aluminum, plastic, ceramic, etc.). Regardless, the results of method 400 can be substantially the same.

Step 460 includes importing the non-concrete construction object in the second format into the destination construction modeling engine as a concrete construction structure. One should appreciate that the step of importing could occur before or after step 455.

Step 470 includes configuring the destination construction modeling engine to present the concrete construction structure to the engineer. In some embodiments, the conversion engine is integrated within the destination modeling engine so that once the conversion takes place; the concrete construction structures are automatically updated. In other embodiments, the conversion engine is a distinct entity. In such scenarios, the destination modeling tool can then execute step 455 to ensure the structures have a proper material type. For example, a macro can be run in Intergraph PDS that changes temporary material types, “steel” for example, to “concrete”.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of modeling concrete construction structures, the method comprising:
providing access to a source construction modeling engine that lacks support for exporting concrete members within a construction design;
modeling a desirable concrete construction structure within the source construction modeling engine;
exporting the construction structure as a non-concrete construction object according to a first format;
using a conversion engine other than the source modeling engine to identify the non-concrete construction object as a representation of the desirable concrete construction structure and to convert the non-concrete construction object from the first format to a second, different format;
importing the non-concrete construction object in the second format into a destination construction modeling engine as a concrete construction structure; and
configuring the destination construction modeling engine to present the concrete construction structure.

2. The method of claim 1, wherein the first format comprises Steel Detailing Neutral Format (SDNF).

3. The method of claim 1, wherein the first format comprises CIMSteel integration standard format.

4. The method of claim 1, wherein the second format comprises a modified form of the first format.

5. The method of claim 1, wherein the source construction modeling engine comprises a RISA Technologies™ structural analysis engine.

6. The method of claim 1, wherein the destination construction modeling engine comprises Intergraph PDS® computer aided design engine.

7. The method of claim 1, wherein the non-concrete construction objects represents a steel structure.

8. The method of claim 1, wherein the step of using the conversion engine further includes allowing a user to identify the non-concrete construction object according to an attribute.

9. The method of claim 8, further comprising allowing the user to select the non-concrete construction object among multiple non-concrete construction objects by attribute type.

10. The method of claim 9, wherein the attribute type comprises at least one of the following: a member type, a shape name, and an angle identifier.

11. The method of claim 1, wherein the non-concrete construction object comprises at least one of the following: a beam, a column, a pipe, a tube, and a brace.

12. The method of claim 1, wherein the step of using the conversion engine includes the conversion engine converting from a first coordinate system associated with the source modeling engine to a second, different coordinate system associated with the destination modeling engine.

13. The method of claim 1, further comprising a providing a rule set that governs conversion of the non-concrete construction object from the first format to the second, different format as a function of properties of the source and the destination modeling engines.

14. The method of claim 1, further comprising the tagging the non-concrete construction object with a temporary material attribute other than concrete indicating the non-concrete construction object as a concrete object.

15. The method of claim 14, further comprising converting a material attribute of the non-concrete construction object from a non-concrete material identifier to a concrete material identifier as a function of the temporary material attribute.

16. The method of claim 15, wherein the step of converting the material attribute includes the destination modeling engine automatically converting the material attribute.
